(19) United States
(12) Patent Application Publication
(10) Pub. No.: US 2026/0001326 A1
(43) Pub. Date: Jan. 1, 2026

(54) LIQUID EJECTING HEAD, LIQUID EJECTING APPARATUS AND HEAD SUPPORTING APPARATUS

(71) Applicant: BROTHER KOGYO KABUSHIKI KAISHA, Nagoya (JP)

(72) Inventor: Rie JOBOJI, Nagoya (JP)

(73) Assignee: BROTHER KOGYO KABUSHIKI KAISHA, Nagoya (JP)

(21) Appl. No.: 19/214,474

(22) Filed: May 21, 2025

(30) Foreign Application Priority Data
Jun. 26, 2024 (JP) 2024-103308

(51) Int. Cl. B41J 2/14; B41J 2/155; B41J 25/316

(52) U.S. Cl. CPC B41J 2/14; B41J 2/155; B41J 25/316

(57) ABSTRACT

A liquid ejecting head includes a channel member which has: a plurality of nozzles configured to eject a liquid, and a channel configured to supply the liquid to the plurality of nozzles, a reference projection which is a projection projected in a direction opposite to an ejecting direction of the liquid from the plurality of nozzles being formed in a surface of the channel member. An outer surface of the reference projection passes through at least three points equidistant from an axis passing through a reference nozzle, which is any one of the plurality of nozzles, along the ejecting direction, the at least three points being located, respectively, at mutually different positions in a circumferential direction of which center is the axis.

### REFERENCE TO RELATED APPLICATIONS

This application claims priority from Japanese Patent Application No. 2024-103308 filed on Jun. 26, 2024. The entire content of the priority application is incorporated herein by reference.

### BACKGROUND ART

A recording apparatus capable of adjusting the posture (inclination) of a recording head (liquid ejecting head) is known. In this recording apparatus, two locations in the outer circumference of a head holder which holds the recording head are formed in the shape of a cylindrical surface having a predetermined radius, with the position of the rotary axis line as the center of the rotation, and a first supporting part and a second supporting part which construct a head posture-adjusting means are in contact with the cylindrical surfaces of these two locations. A pressing spring presses the head holder to cause the head holder to rotate in one direction, and a stopper (adjusting screw) is disposed so as to stop the rotation. The screw is operated to thereby change the position of the stopper and to thereby cause the head to rotate, and thus the posture (inclination) of the head can be adjusted while maintaining the position of the rotary axis line, set to the position of any one of nozzles, with respect to the apparatus.

### SUMMARY

In the above-described recording apparatus, the position of the rotary axis line of the head (the position of the center of rotation) can be maintained under the condition that the first supporting part and the second supporting part are in contact with the appropriate locations in the outer circumference of the head holder. Therefore, in a case where the first supporting part and the second supporting part are not in contact with the appropriate locations in the outer circumference of the head holder, the position of the center of the rotation is deviated.

An object of the present disclosure is to provide a liquid ejecting head, a liquid ejecting apparatus and a head supporting apparatus each of which contributes to controlling any deviation in the position of the center of rotation relating to the adjustment of inclination of the head.

A liquid ejecting head according to a first aspect of the present disclosure includes: a channel member including: a plurality of nozzles configured to eject a liquid; a channel configured to supply the liquid to the plurality of nozzles; and a reference projection located in a surface of the channel member and projected in a direction opposite to an ejecting direction of the liquid from the plurality of nozzles. An outer surface of the reference projection passes through at least three points equidistant from an axis passing through a reference nozzle, which is one of the plurality of nozzles, along the ejecting direction, the at least three points being located, respectively, at mutually different positions in a circumferential direction of which center is the axis.

A liquid ejecting head according to a second aspect of the present disclosure includes: a channel member including: a plurality of nozzles configured to eject a liquid; a channel configured to supply the liquid to the plurality of nozzles; and a reference recessed part located in a surface of the channel member and recessed in an ejecting direction of the liquid from the plurality of nozzles. An inner surface of the reference recessed part passes through at least three points equidistant from an axis passing through a reference nozzle, which is one of the plurality of nozzles, along the ejecting direction, the at least three points being located, respectively, at mutually different positions in a circumferential direction of which center is the axis.

A head supporting apparatus according to the present disclosure is a head supporting apparatus configured to support the liquid ejecting head as defined in the liquid ejecting head according to the first aspect of the present disclosure, the head supporting apparatus including: a fitting part having a recessed part, configured to fit with the reference projection, formed therein; and a moving mechanism configured to move the fitting part.

According to the first aspect of the present disclosure, the outer surface of the reference projection passes through at least the three points which are equidistant from the axis passing through the reference nozzle. Therefore, the liquid ejecting head can be rotated about the reference nozzle, by, for example, rotating the reference projection around the axis which is equidistant from the above-described three points, while supporting the reference projection. Therefore, as compared with a conventional apparatus in which the head is moved using a member brought into contact with the side surface of the head, any deviation in the position of the center of rotation relating to the adjustment of inclination of the head can be controlled.

According to the second aspect of the present disclosure, the inner surface of the reference recessed part passes through at least the three points which are equidistant from the axis passing through the reference nozzle. Therefore, the liquid ejecting head can be rotated about the reference nozzle, by, for example, rotating the reference recessed part about the axis which is equidistant from the above-described three points, while supporting the reference recessed part using a member having a projection which fits with the reference recessed part. Therefore, as compared with the conventional means in which the head is moved using the member brought into contact with the side surface of the head, any deviation in the position of the center of rotation relating to the adjustment of inclination of the head can be controlled.

According to the head supporting apparatus of the present disclosure, the head can be moved, with the position of the reference nozzle as the reference, by moving the fitting part while causing the reference projection to fit into the recessed part.

### BRIEF DESCRIPTION OF DRAWINGS

FIG. 1 is a plan view of a printer according to a first embodiment as an embodiment of the present invention.

FIG. 2 is a block diagram depicting the electrical configuration of the printer of FIG. 1.

FIG. 3 is a front view of the head installed in the printer of FIG. 1.

FIG. 4 is a bottom view of a nozzle surface included in the head in FIG. 1.

FIG. 5 is a perspective view of the head of FIG. 3.

FIG. 6 is a plan view of a reference projection formed in the head of FIG. 3.

FIG. 7 is a bottom view of the head of FIG. 3. The illustration of nozzles is omitted in FIG. 7.

FIG. 8 is an enlarged view of a range indicated by an oval in FIG. 3.

FIG. 9 is a perspective view of a head supporting apparatus which supports the head of FIG. 3.

FIG. 10 is a cross-sectional view of a moving mechanism included in the head supporting apparatus of FIG. 9, taken along a plane orthogonal to a sheet width direction.

FIG. 11 is a cross-sectional view, along the plane orthogonal to the sheet width direction, of a head of a second embodiment as another embodiment of the present invention.

FIG. 12 is a plan view of a reference recessed part formed in the head of FIG. 11.

FIGS. 13A, 13B, and 13C are each a cross-sectional view, along a plane orthogonal to the vertical direction, of a reference projection according to a modification.

### DESCRIPTION

### First Embodiment

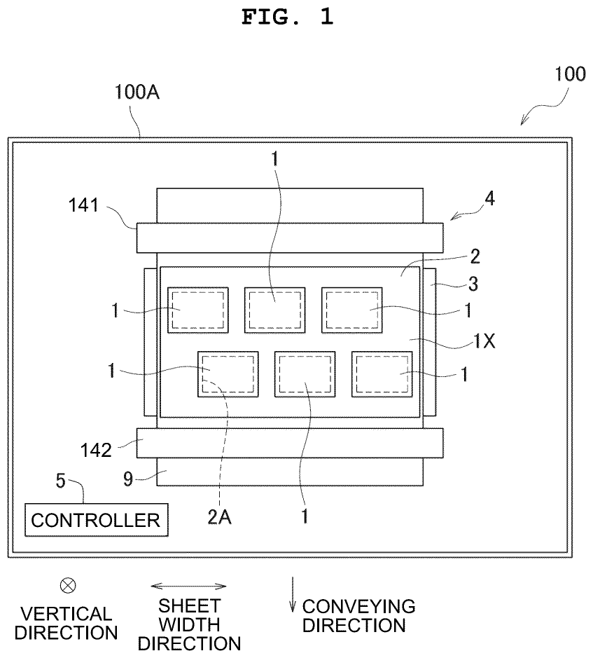

A head 1 and a printer 100 depicted in FIG. 1 correspond, respectively, to a liquid ejecting head and a liquid ejecting apparatus each as a first embodiment according to the present invention. The head 1 is included in the printer 100 of the line type. The printer 100 includes a casing 100A, a base plate 2 to which six heads 1 are attached, a platen 3, a conveyor 4, and a controller 5. The head 1, the base plate 2, the platen 3, the conveyor 4, and the controller 5 are disposed inside the casing 100A. The term “controller” encompasses both a single controller or a group of multiple controllers located either locally or remotely working together or in a distributed fashion to collectively perform the tasks attributed to the “controller” described herein.

The base plate 2 (corresponding to a “base member” of the present invention) is a rectangular member having a shape of a flat rectangular plate along a plane parallel to both a sheet width direction and a conveying direction, and the base plate 2 is fixed to the casing 100A. The sheet width direction is a direction along the width of a sheet 9, and is orthogonal to the vertical direction. The base plate 2 has six attaching holes 2A each of which is configured to attach one of the six heads 1 therein. Each of the six attaching holes 2A penetrates the base plate 2. Note that the upper surface of the base plate 2 corresponds to “one surface of the base member” of the present invention, and the lower surface of the base plate 2 corresponds to “the other surface of the base member” of the present invention.

The six heads 1 are fixed to the base plate 2 while being positioned along a plane parallel to both the sheet width direction and the conveying direction. This allows the six heads 1 to be disposed in a staggered manner with respect to the sheet width direction. The length of each of the six heads 1 in the sheet width direction is longer than the length of each of the six heads 1 in the conveying direction. A lower part of each of the six heads 1 (a part corresponding to a nozzle formation member 30 to be described later) penetrates one of the attaching holes 2A of the base plate 2 in a direction from the upper surface toward the lower surface of the base plate 2 (the vertically downward).

The platen 3 is a plate along a plane orthogonal to the vertical direction, and is disposed at a location below the head unit 1 X. The sheet 9 is supported on the upper surface of the platen 3.

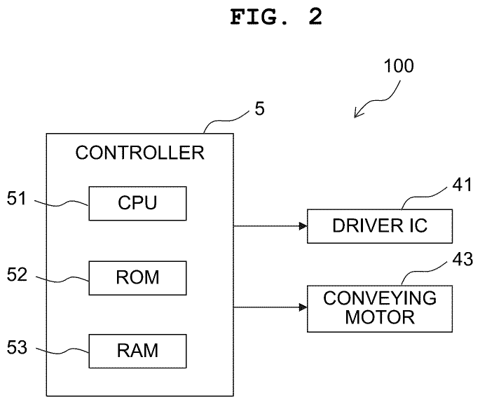

The conveyor 4 includes a roller pair 141 having two rollers, a roller pair 142 having two rollers, and a conveying motor 43 depicted in FIG. 2. In the conveying direction, the six heads 1, the base plate 2, and the platen 3 are disposed between the roller pair 141 and the roller pair 142. The conveying direction is orthogonal to the vertical direction and the sheet width direction.

In a case where the conveying motor 43 is driven by the control of the controller 5, the rollers of the roller pairs 141 and 142 rotate. As the rollers of the roller pairs 141 and 142 rotate, the sheet 9 held by the rollers of the roller pairs 141 and 142 is thereby conveyed in the conveying direction.

As depicted in FIG. 2, the controller 5 includes a CPU 51, a ROM 52, and a RAM 53.

The CPU 51 executes various kinds of control in accordance with a program and data stored in the ROM 52 and/or the RAM 53, based on data input from an external device. The external device is, for example, a personal computer (PC).

The ROM 52 stores the program and the data with which the CPU 51 performs the various kinds of control. The RAM 53 temporarily stores data to be used in a case where the CPU 51 executes the program.

Next, the configuration of each of the six heads 1 will be described.

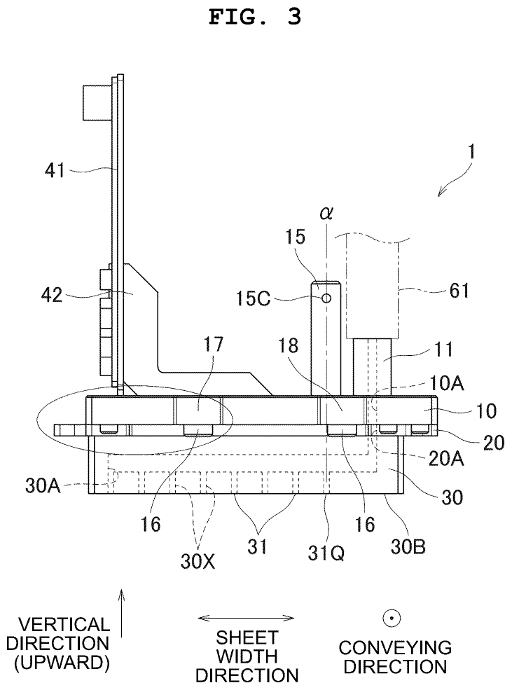

Each of the heads 1 includes a supply member 10, an alignment plate 20, a nozzle formation member 30, and a driver IC 41 which are stacked in the vertical direction, as depicted in FIG. 3.

The supply member 10 (corresponding to a “second channel member” of the present invention) is stacked on a surface, of the nozzle formation member 30, which is on the opposite side to a nozzle surface 30B to be described later, with the alignment plate 20 sandwiched between the nozzle formation member 30 and the supply member 10. The supply member 10 is made of a synthetic resin material (e.g., polyacetal resin), and has a body formed in a shape of a flat plate. A tube connecting part 11 is formed in the upper surface of the supply member 10. The tube connecting part 11 projects vertically upward from the upper surface of the supply member 10. One end of an ink tube 61 is connected to the tube connecting part 11. The tube connecting part 11 and the ink tube 61 are connected to each other, for example, via a joint. The joint is fixed to the tube connecting part 11 by a screw, etc., via a seal member such as an O-ring, etc. The other end of the ink tube 61 is connected to an ink cartridge disposed inside the casing 100A. An ink in the ink cartridge is supplied to the tube connecting part 11 through the ink tube 61. A through hole 10A, which serves as a channel for the ink supplied to the tube connecting part 11, is formed in the supply member 10. The through hole 10A is connected to an opening formed in the upper surface of the tube connecting part 11, and extends downward from the opening and into the inside the tube connecting part 11. The lower end of the through hole 10A is open in the lower surface of the supply member 10.

The alignment plate 20 is a member having a shape of a flat plate which is parallel to both the sheet width direction and the conveying direction. The supply member 10 and the nozzle formation member 30 are fixed to the alignment plate 20. The supply member 10 and the nozzle formation member 30 are positioned with respect to the alignment plate 20. This allows the supply member 10 and the nozzle formation member 30 to be appropriately disposed inside the head 1. The alignment plate 20 has a through hole 20A along the vertical direction formed therein. An opening at the upper end of the through hole 20A is connected to the opening of the through hole 10A of the supply member 10.

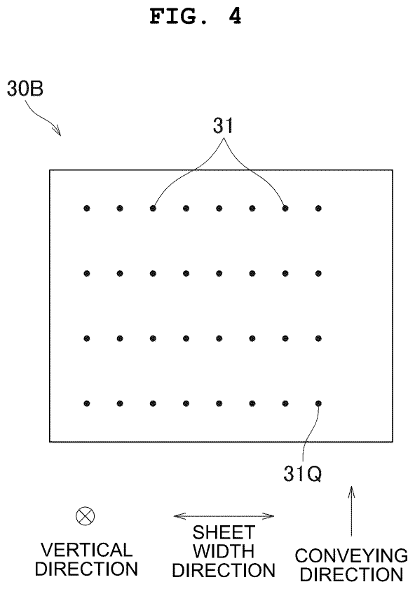

The nozzle formation member 30 (corresponding to a “first channel member” of the present invention) is a metallic member having a plurality of nozzles 31 which eject the ink and an ink channel 30A which supplies the ink to the plurality of nozzles 31 formed therein. The plurality of nozzles 31 are open in the nozzle surface 30B which is the lower surface of the nozzle formation member 30. As depicted in FIG. 4, the plurality of nozzles 31 are aligned in each of the sheet width direction and the conveying direction.

As depicted in FIG. 3, the ink channel 30A has an opening in the upper surface of the nozzle formation member 30. This opening is connected to the opening of the through hole 20A of the alignment plate 20. The ink channel 30A extends downward from the opening at an upper end thereof toward the inside of the nozzle formation member 30, and extends therefrom along the sheet width direction. The ink channel 30A branches into a plurality of individual channels 30X inside the nozzle formation member 30. Each of the plurality of individual channels 30X extends downward and is connected to one of the plurality of nozzles 31 at a lower end of the individual channel 30X.

The ink supplied to the tube connecting part 11 through the ink tube 61 fills the ink channel 30A through the through holes 10A and 20A.

The driver IC 41 has a substrate along the vertical direction and an electronic part on the substrate. The driver IC 41 is driven by the control of the controller 5, and generates an electric signal for causing each of the plurality of nozzles 31 to eject the ink. This electric signal is supplied to an actuator provided on the nozzle formation member 30 through a wiring member 42. The actuator operates by the electric signal supplied from the driver IC 41, and imparts energy to the ink in each of the plurality of individual channels 30X. The ink in each of the plurality of individual channels 30X to which energy has been imparted is supplied to one of the plurality of nozzles 31, and is ejected from one of the plurality of nozzles 31.

Note that in the manufacturing process of the printer 100, in a case where the heads 1 are attached to the base plate 2, the heads 1 and the base plate 2 are subjected to positioning along a plane parallel to both the sheet width direction and the conveying direction. Conventionally, this positioning is performed with a method of bringing a positioning member into contact with the outer circumference of each of the heads or a peripheral member of each of the heads, and moving the positioning member to thereby move the heads. However, with such a conventional positioning method, the center of rotation of each of the heads is deviated, which in turn makes the positioning difficult.

Therefore, in the present embodiment, in order to avoid any deviation of the center of rotation of each of the heads 1 during the positioning, each of the heads 1 is configured as follows.

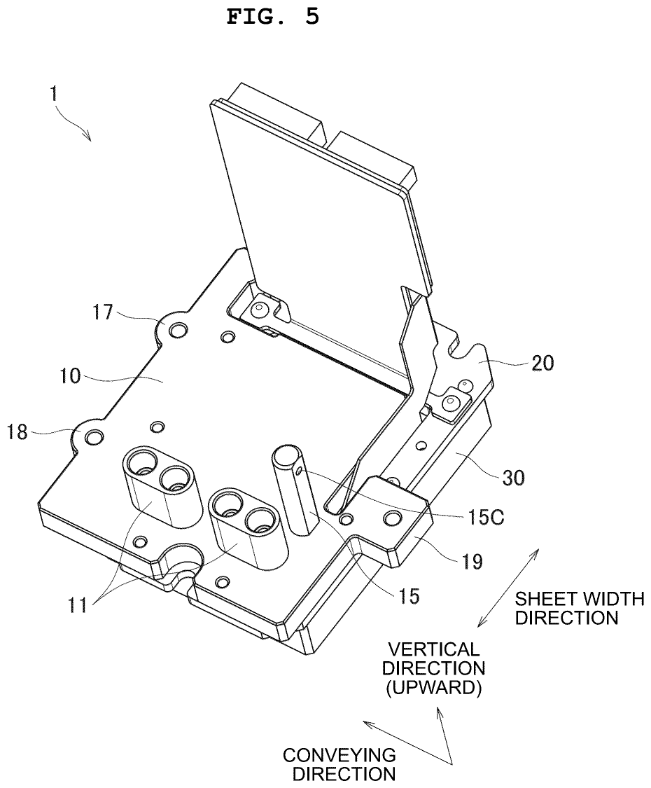

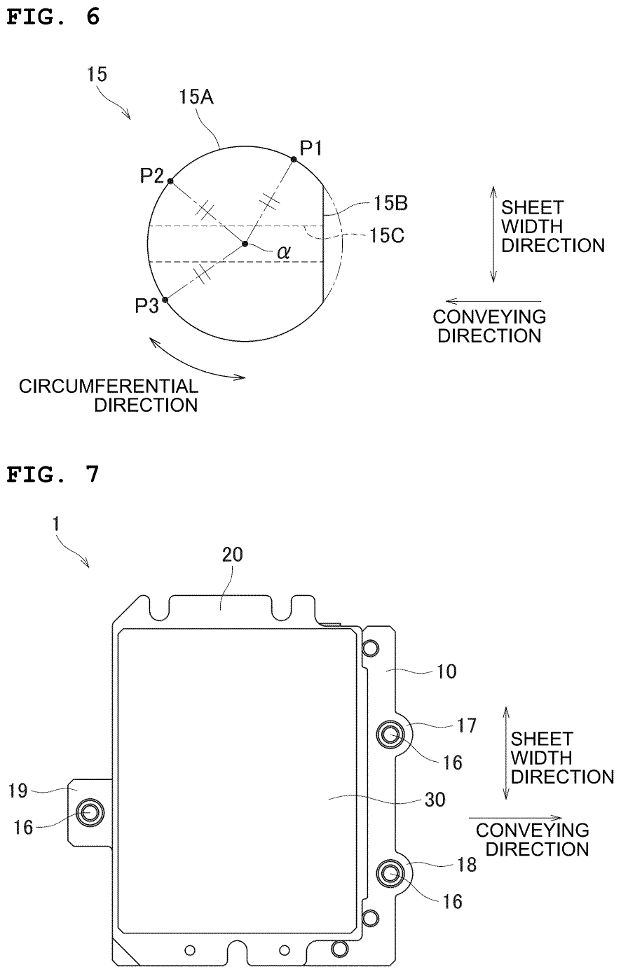

First, each of the heads 1 has a reference projection 15 as depicted in FIG. 3 and FIG. 5. The reference projection 15 is a part of the supply member 10, and is made of the same synthetic resin material as the other parts of the supply member 10 other than the reference projection 15. The reference projection 15 is projected vertically upward from the upper surface, of the body of the supply member 10, which has the shape of the flat plate. The reference projection 15 has an approximate shape obtained by cutting a part of a circular cylinder along a plane parallel to the vertical direction. Therefore, the reference projection 15 has an outer surface 15A along a part of the outer surface of the circular cylinder, and an outer surface 15B along the plane. As depicted in the plan view of FIG. 6, the outer surface 15A is along a circle of which center is an axis a of the circular cylinder, and the outer surface 15B is along the arc of the circle. The axis a is set so as to pass through a reference nozzle 31Q, which is one of the plurality of nozzles 31, along the vertical direction. The reference nozzle 31Q is a nozzle 31 disposed outermost in both the sheet width direction and the conveying direction among the plurality of nozzles 31.

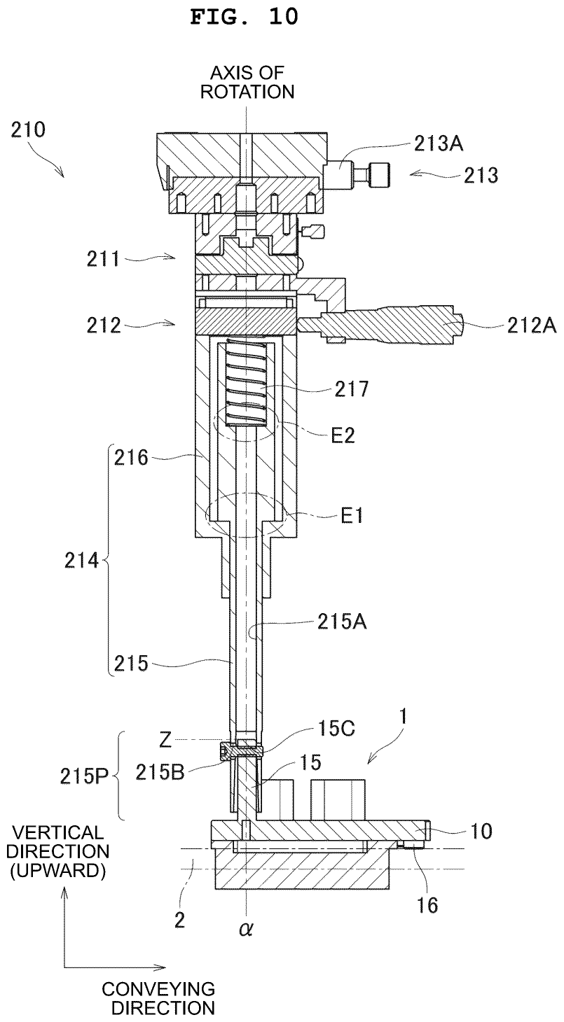

Such a case is assumed that three reference points are taken on the outer surface 15A. The three reference points are taken, respectively, at mutually different positions in the circumferential direction with the axis a as the center thereof, and at mutually the same predetermined positions in the vertical direction (for example, position Z in FIG. 10), as exemplified by points P1, P2, and P3 depicted in FIG. 6. In this situation, the three reference points are equidistant from the axis α. That is, the distances each of which is between the axis a and one of the three reference points and the axis a are mutually the same. Further, the outer surface 15A of the reference projection 15 extends along the axis a while passing through all of the three reference points. Furthermore, the outer surface 15A of the reference projection 15 extends along the circumferential direction, with the axis a as the center thereof, while passing through all of the three reference points. An upper part of the reference projection 15 has a through hole 15C formed therein and penetrating the reference projection 15 in the conveying direction (see FIG. 3, FIG. 5, and FIG. 6).

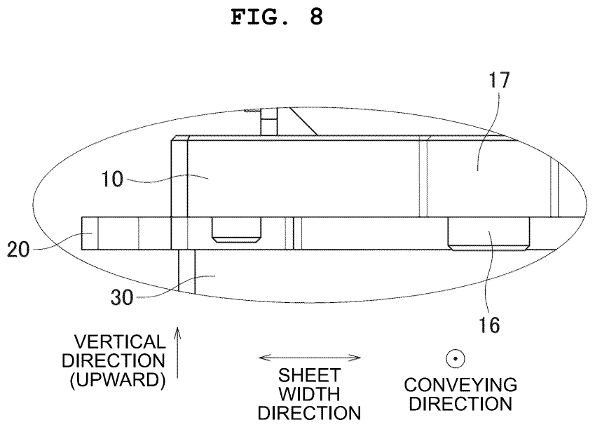

Secondly, each of the heads 1 has three lateral-projections 16 depicted in FIG. 7 and FIG. 8. Each of the three lateral-projections 16 is a part of the supply member 10 and is made of the same synthetic resin material as the other parts, of the supply member 10, other than the three lateral-projections 16. The three lateral-projections 16 are formed, respectively, in extended parts 17 to 19 of the supply member 10. The extended parts 17 to 19 are, respectively, partially extended parts of the body, which has the shape of the flat plate, of the supply member 10. The extended parts 17 and 18 are extended in the conveying direction, and the extended part 19 is extended in a direction opposite to the conveying direction. As depicted in FIG. 7, the nozzle formation member 30 is interposed, in the conveying direction, between the two lateral-projections 16 formed, respectively, in the extended parts 17 and 18 and the lateral-projection 16 formed in the extended part 19.

Each of the three lateral-projections 16 is projected downward from the lower surface of one of the extended parts 17 to 19 up to a location on a side of the nozzle formation member 30. The phrase the “location adjacent to the nozzle formation member 30” indicates an area in which the nozzle formation member 30 exists in the vertical direction, and corresponds to a position outside the nozzle formation member 30 in the conveying direction or the sheet width direction. FIG. 8 depicts a state that each of the three lateral-projections 16 is projected up to the location adjacent to the nozzle formation member 30 slightly beyond the alignment plate 20 in the vertical direction. Each of the three lateral-projections 16 is a part which is projected most vertically downward at the location adjacent to the nozzle formation member 30.

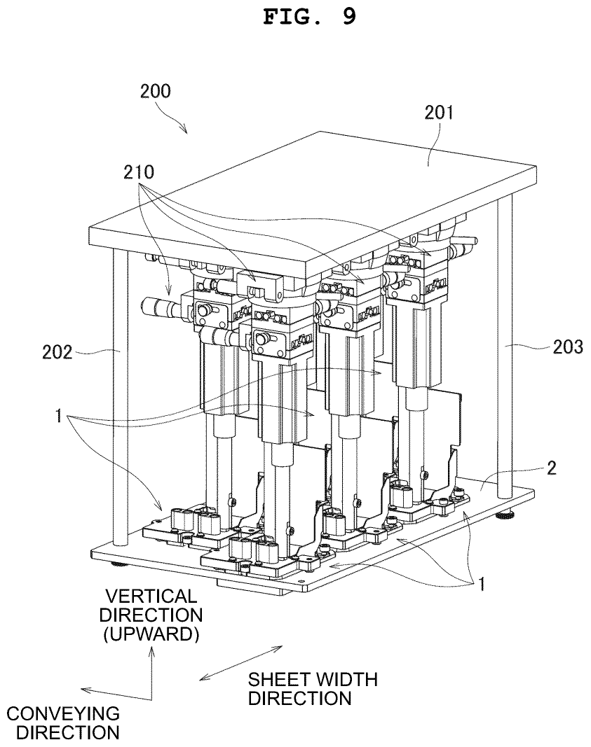

In the following, a method of positioning each of the heads 1 with respect to the base plate 2 will be described. As depicted in FIG. 9, a head supporting apparatus 200 used in this positioning method has a mount 201, a support column 202, a support column 203, and six moving mechanisms 210. The mount 201 is a member having a shape of a flat plate. The support column 202 and the support column 203 are fixed, respectively, the diagonal corners of the mount 201. The support column 202 and the support column 203 extend from the mount 201 in a direction orthogonal to the mount 201, and are fixed to the diagonal corners of the base plate 2 at the respective forward ends thereof. The base plate 2 is disposed parallel to the mount 201 so that the surface to which the heads 1 are attached faces the mount 201. Further, the six heads 1 are disposed on the base plate 2, with the lateral-projections 16 being brought in contact with the surface of the base plate 2, as depicted in FIG. 10.

In the following description, the same three directions which are the sheet width direction, the conveying direction and the vertical direction, are used so that the relationship between the three directions and the base plate 2 in the printer 100 is maintained also regarding the base plate 2 disposed in parallel to the mount 201.

The six moving mechanisms 210 correspond, respectively, one-to-one to the six heads 1. Each of the six moving mechanisms 210 is attached to a surface, of the mount 201, facing the base plate 2. Each of the six moving mechanisms 210 has a translational moving part 211, a translational moving part 212, a rotational moving part 213, and a holding part 214.

The holding part 214 is a part configured to move translationally by the translational moving parts 211 and 212 and to move rotationally by the rotational moving part 213, while holding the heads 1. The holding part 214 has an inner cylinder part 215 (corresponding to a “fitting part” of the present invention) and an outer cylinder part 216. An upper part of the inner cylinder part 215 is disposed inside the outer cylinder part 216. A lower part of the inner cylinder part 215 is projected from an opening at a lower end of the outer cylinder part 216 to the outside of the outer cylinder part 216 and extends linearly toward the base plate 2.

The outer surface of the inner cylinder part 215 has a stepped part E1 which is formed between an upper part and a lower part of the outer surface. A stepped part of an inner surface of the outer cylinder part 216 is brought into contact with the stepped part E1 of the inner cylinder part 215, thereby regulating the downward movement of the inner cylinder part 215. A spring 217 is disposed in the upper part inside the inner cylinder part 215. An upper end of the spring 217 is projected upward from the inner cylinder part 215, and the spring 217 is fixed to the translational moving part 212 at the upper end, of the spring 217, located inside the outer cylinder part 216. A lower end of the spring 217 is brought into contact with the stepped part E2 formed in the inner surface of the inner cylinder part 215 from above the stepped part E2, and applies an elastic force to the inner cylinder part 215 so as to move the inner cylinder part 215 downward.

The inner cylinder part 215 has a through hole 215B which is formed in an upper part of a lowermost part 215P of the inner cylinder part 215, and which penetrates the inner cylinder part 215 in the conveying direction.

The inner cylinder part 215 has a cavity 215A formed therein. The cavity 215A has an opening at a forward end of the lowermost part 215P of the inner cylinder part 215. The reference projection 15 of each of the heads 1 is inserted into the opening of the cavity 215A, as described below. In other words, the lowermost part 215P of the inner cylinder part 215 functions as a recessed part which fits with the reference projection 15 of each of the heads 1.

In the lowermost part 215P of the inner cylinder part 215, the cavity 215A becomes wider, in both directions which are the sheet width direction and the conveying direction, further at a location closer to the opening of the forward end. In other words, the cavity 215A is formed in a tapered shape. In a direction orthogonal to the vertical direction, the cross-sectional shape, of the cavity 215A, at the lowermost part 215P has a similar relationship to the relationship regarding the cross-sectional shape of the reference projection 15 of each of the heads 1. Further, the cross section, of the cavity 215A, at the lowermost part 215P is the same size as the cross-section of the reference projection 15 of each of the heads 1, at a position Z slightly above the through hole 215b in the vertical direction.

In each of the six moving mechanisms 210, the reference projection 15 of one of the six heads 1 is inserted from below and into the lowermost part 215P of the inner cylinder part 215. In this situation, the reference projection 15 is smoothly guided into the inner cylinder part 215 by the cavity 215A having the tapered form. Further, the inner cylinder part 215 is pressed toward the reference projection 15 by the spring 217. As a result, the inner cylinder part 215 and the reference projection 15 are fitted with each other, without a gap at the position Z. In this state, the holding part 214 is disposed so that a part, in the inner surface of the cavity 215A, which is in contact with the outer surface 15A of the reference projection 15 is equidistant from the axis of rotation of the holding part 214 by the rotational moving part 213. In this situation, in a case where the three reference points (the points P1, P2, and P3 in FIG. 6) are taken at the position Z on the outer surface 15A as described above, these three reference points are equidistant from both the axis of rotation of the holding part 214 by the rotational moving part 213 and the axis α. In other words, in a case where the inner cylinder part 215 and the reference projection 15 are fitted with each other, the axis of rotation of the holding part 214 by the rotational moving part 213 and the axis a are coincident. Further, in a case where the inner cylinder part 215 and the reference projection 15 are fitted with each other, the through hole 15C of the reference projection 15 and the through hole 215B of the inner cylinder part 215 are aligned in the conveying direction. The fixing pin 215B is inserted into the through holes 15C and 215B in this state. With this, the holding part 214 and each of the heads 1 are fixed with each other.

The translational moving parts 211 and 212 and the rotational moving part 213 cause the holding part 214 to move in a direction along the base plate 2. In a case where the holding part 214 moves, each of the heads 1 held by the holding part 214 moves relative to the base plate 2 while bringing the lateral-projections 16 into contact with the base plate 2.

Each of the translational moving parts 211 and 212 and the rotational moving part 213 has a knob which can be manually operated. For example, FIG. 10 depicts a knob 212A of the translational moving part 212 and a knob 213A of the rotational moving part 213. By manually operating these knobs 212A and 213B, the holding part 214 can be translationally and rotationally moved.

The translational moving parts 211 and 212 and the rotational moving part 213 are disposed on an extension line of the axis a in a state that the inner cylinder part 215 and the reference projection 15 are fitted with each other. The translational moving part 212 translationally moves the holding part 214 parallel to the conveying direction. The translational moving part 211 is disposed on the translational moving part 212 and translationally moves the translational moving part 212 and the holding part 214 together in the sheet width direction. The rotational moving part 213 is disposed on the translational moving part 211 and moves the translational moving part 211, the translational moving part 212 and the holding part 214 together in the direction of rotation of which center is the axis α.

According to the present embodiment as described above, the reference projection 15 has the outer surface 15A. The outer surface 15A corresponds to the part, of the outer surface, of the circular cylinder of which center is the axis a passing through the reference nozzle 31Q along the vertical direction. Therefore, the three reference points (e.g., the points P1, P2, and P3 in FIG. 6) which are equidistant from the axis a can be set at the predetermined positions (e.g., each at the position Z in FIG. 10) on the outer surface 15A. Therefore, each of the heads 1 can be positioned based on the three reference points, while the axis a is being grasped or confirmed.

For example, in a case where the above-described head supporting apparatus 200 is used and where the holding part 214 of each of the six moving mechanisms 210 is caused to support the reference projection 15, the inner cylinder part 215 and the reference projection 15 are fitted with each other without a gap at the position Z in FIG. 10. In this situation, as appreciated from the foregoing description, the axis of rotation of the holding part 214 by the rotational moving part 213 coincides with the axis α, based on the three reference points. Therefore, the rotational moving part 213 is capable of rotating each of the heads 1 about the axis a passing through the reference nozzle 31Q. Therefore, any deviation in the position of the center of rotation related to the adjustment of inclination of each of the heads 1 can be easily avoided, as compared with the conventional means for moving each of the heads using the member brought into contact with the side surface of each of the heads.

According to the conventional positioning method, as described above, the positioning member is brought into contact with the outer circumference of each of the heads or of the peripheral member of each of the heads, and each of the heads is moved by moving this positioning member. In this method, the positioning member is placed around each of the heads. For this reason, for example, in a case where the distance between the heads is short, the positioning member cannot be disposed easily. Further, in a case where the position of the heads fixed in the apparatus is to be adjusted again after the positioning has been performed, disposing the conventional positioning member around each of the heads is extremely difficult, since the ink tube, etc., is already connected to each of the heads. In contrast, in the present embodiment, the holding part 214 only needs to be connected to the reference projection 15 from vertically above. For this reason, even in a case where the distance between the heads 1 is short and/or in a case where the ink tube 61, etc., is connected to each of the heads 1, the positioning can be easily performed.

Furthermore, in the present embodiment, since the outer surface 15A corresponds to the part of the outer surface of the circular cylinder, the outer surface 15A extends along the circumferential direction of which center is the axis α, while passing through all of the three reference points. Therefore, for example, in a case where the inner cylinder part 215 and the reference projection 15 are fitted with each other without any gap at the position Z, the inner cylinder part 215 and the reference projection 15 are brought into contact with each other along the circumferential direction, without the gaps. This allows the rotation around the axis a by the rotational moving part 213 to be performed with high precision. Moreover, the outer surface 215A extends along the axis a while passing through all of the three reference points. Therefore, the inner cylinder part 215 and the reference projection 15 can be fitted with each other with high precision.

Moreover, in the present embodiment, the reference projection 15 is formed of the synthetic resin material. Therefore, a material suitable for supporting and/or moving the reference projection 15 can be easily selected. For example, a material which can be easily fitted with the inner cylinder part 215 of the head supporting apparatus 200 can be selected.

Further, in the present embodiment, the reference nozzle 31Q, which is the reference of the axis α, is disposed outermost in both the conveying direction and the sheet width direction among the entire plurality of nozzles 31. With this, the reference nozzle 31Q can be easily recognized visually in the positioning operation of each of the heads 1. This is based on the following reason. For example, such a case is assumed where the reference nozzle is set to be the third nozzle 31 from the outer side among the plurality of nozzles 31 formed in each of the heads 1. In this situation, an operator cannot easily distinguish and recognize the third nozzle 31 from the fourth nozzle and/or the second nozzle, and there is a risk that the operator might erroneously recognize the position of the reference nozzle. In contrast, in the case where the reference nozzle 31Q is disposed outermost, the above-described error in the recognition is less likely to occur. Further, in a case where the position of the reference nozzle is confirmed while capturing the nozzles 31 with a camera, the magnification of the camera is set, for example, so as to capture mutually adjacent nozzles 31 of which number is approximately three are placed within the field of view of the camera, in some cases. In this situation, in a case where the reference nozzle 31Q disposed outermost is placed in the center of the field of view, a nozzle 31 is present next to and at one of the both sides of the reference nozzle 31Q, and no nozzle 31 is present next to and at the other of the both sides of the reference nozzle 31Q. With this, the reference nozzle can be captured easily and accurately.

Further, in the present embodiment, the reference projection 15 is disposed in each of the heads 1 as the part of the supply member 10. The supply member 10 is the member which supplies the ink to the nozzle formation member 30, and is stacked on the surface, of the nozzle formation member 30, which is on the side opposite to the nozzle surface 30B. A certain member stacked on the member in which nozzles are formed and which supplies the ink to the member, such as the supply member 10, has a connection part with an ink supply source, such as the tube connecting part 11, disposed therein, in many cases. Further, the connection part is fixed to the joint by the screw, etc., via the seal member as described above. In this situation, a screw-stopping location subjected to the fixing by the screw is included as three or four locations which are spaced apart from one another so that the seal member is crushed evenly. For this reason, the entirety of the member is required to have a size to a certain extent, and thus such a relatively large member has the advantage that a space for forming the reference projection 15 can be easily secured.

Furthermore, in the present embodiment, the three lateral-projections 16, which are projected from the supply member 10 up to the location adjacent to the nozzle formation member 30, are formed. Moreover, in a case where the positioning of each of the heads 1 is performed by using the head supporting apparatus 200, each of the heads 1 is moved while only the lateral-projections 16 are brought into contact with the base plate 2. For this reason, the frictional resistance generated in each of the heads 1 during the positioning can be easily lowered by, for example, forming the lateral-projections 16 using a material (e.g., polyacetal resin) and/or a shape each of which is less likely to generate the frictional resistance with respect to each of the heads 1.

Further, in the present embodiment, each of the lateral-projections 16 is the part which is projected most vertically downward at the location adjacent to the nozzle formation member 30. That is, in each of the heads 1, other than the nozzle formation member 30, no part which is projected more than the lateral-projections 16 is present. Therefore, each of the heads 1 can be easily moved while the lateral-projections 16 are brought into contact with the base plate 2. For example, as described above, a material with good sliding performance such as polyacetal resin, etc., is adopted, and the lateral-projections 16 are adjusted to have a shape which minimizes the area of contact with the base plate 2. With this, each of the heads 1 can be smoothly moved while the lateral-projections 16 are brought into contact with the base plate 2 during the positioning. In a case where the movement of the head 1 is not smooth, the head 1 might stuck. In a case where the head 1 is forcibly moved in a state where the head 1 is stuck, the head 1 might move by a large amount at once, which in turn might make stopping the head 1 at a desired position difficult. In a case where the movement of the head 1 becomes smooth as described above, such problems can be avoided.

Further, in the present embodiment, the plurality of lateral-projections 16 are disposed so that the nozzle formation member 30 is interposed between the plurality of lateral-projections 16. Therefore, in a case where the plurality of lateral-projections 16 are brought into contact with the base plate 2, the nozzle formation member 30 is stably supported.

Furthermore, in a case where the head supporting apparatus 200 is used to position each of the heads 1 according to the present embodiment, each of the six moving mechanisms 210 moves the inner cylinder part 215 fitted with the reference projection 15. This allows each of the six heads 1 to translationally move and/or rotationally move, with the axis a as the reference of the movement.

Moreover, in the head supporting apparatus 200 according to the present embodiment, the cavity 215A in the inner cylinder part 215 is formed in the tapered shape. With this, the reference projection 15 is smoothly guided into the inner cylinder part 215, and thus the inner cylinder part 215 and the reference projection 15 can be easily fitted with each other. In such a presumed case where the cavity 215A in the inner cylinder part 215 is not formed in the tapered shape, any looseness (deviation in the fitting) might occur in a case where the reference projection 15 and the inner cylinder part 215 are fitted with each other. In a case where such a looseness occurs, the center of rotation of the head 1 in each of the moving mechanisms 210 might be deviated from the axis α. In contrast, in the above-described embodiment, since the cavity 215A is formed in the tapered shape, the reference projection 15 can move smoothly until the reference projection 15 is fitted into the inner cylinder part 215 without any gap at the position Z in FIG. 10. Accordingly, the occurrence of looseness can be avoided and the center of rotation can be easily coincident with the axis α.

Further, in the head supporting apparatus 200 according to the present embodiment, the rotational moving part 213 of each of the six moving mechanisms 210 is disposed on the extension line of the axis α. Therefore, the rotational moving part 213 is disposed in a space-saving manner.

### Second Embodiment

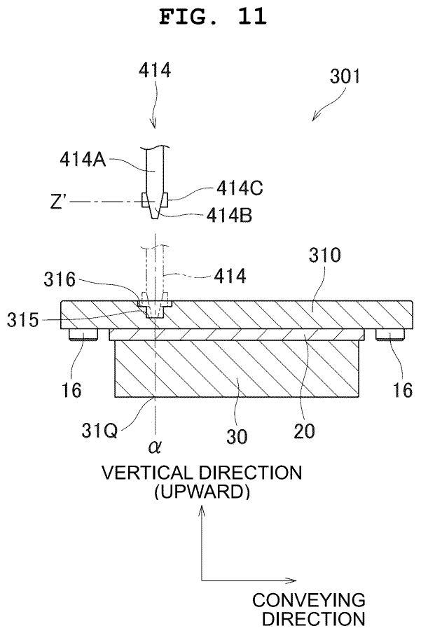

In the following, a head 301 according to a second embodiment, which is another embodiment of the present invention, will be described with reference to FIG. 11 and FIG. 12. The head 301 can be substituted for the head 1 according to the first embodiment. The head 301 has many common configurations with the head 1. Therefore, in the following description, these common configurations are denoted with the same reference numerals as the first embodiment as described above, and the description thereof will be omitted as appropriate.

The head 301 is a head 1 using a supply member 310, rather than the supply member 10. The supply member 310 is made of a synthetic resin material and has a body having a shape of a flat plate. In the supply member 310, a channel which supplies an ink to an alignment plate 20 and a nozzle formation member 30 is formed in the same manner as in the supply member 10, whereas the supply member 310 has a reference recessed part 315 formed therein, rather than the reference projection 15.

The reference recessed part 315 is a recessed part formed in the upper surface of the body of the supply member 310. The reference recessed part 315 has an inner surface of a cylindrical shape of which center is an axis a passing through a reference nozzle 31Q along the vertical direction. Such a case is assumed that three reference points are taken on the inner surface of the reference recessed part 315. The three reference points are taken, respectively, at mutually different positions in the circumferential direction with the axis a as the center thereof, and at mutually the same predetermined positions in the vertical direction. Points R1, R2 and R3 depicted in FIG. 12 are examples of the three reference points set in the opening of the reference recessed part 315. In this situation, the three reference points are equidistant from the axis α. That is, the distances each of which is between the axis a and one of the three reference points are mutually the same. Further, the inner surface of the reference recessed part 315 extends along the axis a while passing through all of the three reference points. Furthermore, the inner surface of the reference recessed part 315 extends along the circumferential direction, with the axis a as the center thereof, while passing through all of the three reference points.

An engaging recessed part 316 is connected to the center in the sheet width direction of the reference recessed part 315. The engaging recessed part 316 is formed in the upper surface of the body of the supply member 310, and extends from the reference recessed part 315 toward the both sides in the conveying direction.

A holding part 414 configured to move the head 301 is inserted into the reference recessed part 315 as described above. The holding part 414 is used in place of the above-described holding part 214. The holding part 414 has a columnar-shaped body 414A, a tapered part 414B which is projected vertically downward from a lower end of the body 414A, and an engaging projection 414C which is projected parallel to the conveying direction from the tapered part 414B. The tapered part 414B has a truncated cone shape tapered vertically downward. The diameter of the tapered part 414B is adjusted so as to exactly match the diameter of the reference recessed part 315, at a position Z′ slightly below the body 414A.

In a case where the holding part 414 is inserted into the reference recessed part 315 from above, the holding part 414 is smoothly guided into the reference recessed part 315 by the tapered part 414B. Then, as depicted by the two-dot chain lines in FIG. 11, in a case where the holding part 414 is inserted until the location, of the holding part 414, at position Z′ reaches the opening of the reference recessed part 315, the outer surface of the location, of the tapered part 414B, at position Z′ is fitted, without any gap, with the opening of the reference recessed part 315, and the engaging projection 414C is inserted into the engaging recessed part 316. In a case where the outer surface of the tapered part 414B is fitted with the opening of the reference recessed part 315 without any gap, the central axis of the tapered part 414B and the axis a each of which is located at the position equidistant from the three reference points, coincide with each other. In a case where the holding part 414 is rotated about the central axis of the tapered part 414B in this state, the engaging projection 414C and the engaging recessed part 316 are thereby engaged with each other, and thus the head 301 can be rotationally moved about the axis a in conjunction with the rotation of the holding part 414. Further, the head 301 can be translationally moved in a similar manner by translationally moving the holding part 414 in the conveying direction or the sheet width direction.

According to the present embodiment described above, the inner surface of the reference recessed part 315 is formed in the cylindrical shape of which center is the axis a passing through the reference nozzle 31Q along the vertical direction. Therefore, the three reference points which are equidistant from the axis a can be taken, for example, in the opening of the reference recessed part 315. That is, in a case where the holding part 414 is inserted into the reference recessed part 315, the outer surface of the holding part 414 fits with the opening of the reference recessed part 315 without any gap. In this situation, as described above, the axis a and the central axis of the tapered part 414B which are equidistant from the three reference points (the points R1, R2, and R3 in FIG. 12) coincide with each other. Therefore, by rotating the holding part 414 about the central axis of the tapered part 414B, the head 301 can be rotated about the axis a passing through the reference nozzle 31Q. Therefore, any deviation in the position of the center of rotation related to the adjustment of inclination of the heads 301 can be easily avoided, as compared with the conventional means for moving the head using the member brought into contact with the side surface of the head.

Further, in the present embodiment, since the inner surface of the reference recessed part 315 has the cylindrical shape, the inner surface of the reference recessed part 315 extends along the circumferential direction of which center is the axis α, while passing through all of the three reference points. Therefore, for example, in a case where the outer surface of the holding part 414 and the opening of the reference recessed part 315 are fitted with each other without any gap, the outer surface of the holding part 414 and the opening of the reference recessed part 315 are thus brought into contact with each other along the circumferential direction without the gap. As a result, the rotation of the holding part 414 about the axis a is performed with high precision. Furthermore, the inner surface of the reference recessed part 315 extends along the axis a while passing through all of the three reference points. Therefore, the outer surface of the holding part 414 and the opening of the reference recessed part 315 can be fitted with each other with high precision.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

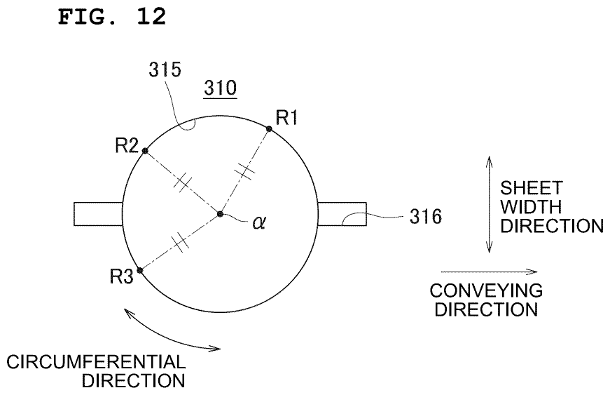

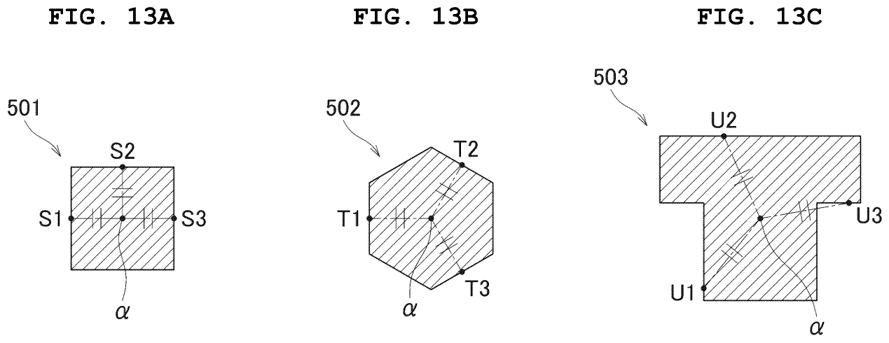

For example, in the above-described embodiments, the reference projection 15 and the reference recessed part 315 are formed in a columnar shape or a cylindrical shape. In other words, the cross-sections in the vertical direction of the reference projection 15 and the reference recessed part 315 are circular shapes. In this regard, a reference projection or a reference recessed part having a cross-sectional shape other than the circular shape may be adopted. For example, a reference projection 501, a reference projection 502, and a reference projection 503 depicted, respectively, in FIG. 13A, FIG. 13B, and FIG. 13C may be adopted. The reference projection 501 has a shape of a rectangular column having a square cross section. In this case, the outer surface of the reference projection 501 can have three reference points S1, S2, and S3 which are equidistant from the axis a in the same cross section. The reference projection 502 has a shape of a rectangular column having a hexagonal cross section. In this case, the outer surface of the reference projection 502 can have three reference points T1, T2, and T3 which are equidistant from the axis a in the same cross section. The reference projection 503 has a columnar shape having a cross section having a shape of the letter “T”. In this case, the outer surface of reference projection 503 can have three reference points U1, U2 and U3 which are equidistant from the axis a in the same cross section. As described above, as long as the three reference points equidistant from the axis a can be taken, a shape of which cross section has a polygonal shape other than the above-described shapes may be adopted, or a shape of which cross section has a shape which is different from the above-described shape such as a closed curve, etc., may be adopted. Further, a reference recessed part having a cross-sectional shape corresponding to each of the cross-sectional shapes as depicted in FIG. 13A, FIG. 13B, and FIG. 13C may be adopted.

Furthermore, in the above-described embodiments, the cavity 215A of the inner cylinder part 215 and the holding part 414 which are paired, respectively, with the reference projection 15 and the reference recessed part 315 each have the tapered shape. In this regard, the reference projection and the reference recessed part may be formed in a tapered shape.

What is claimed is:

1. A liquid ejecting head comprising:
a channel member including:
a plurality of nozzles configured to eject a liquid;
a channel configured to supply the liquid to the plurality of nozzles; and
a reference projection located in a surface of the channel member and projected in a direction opposite to an ejecting direction of the liquid from the plurality of nozzles, wherein
an outer surface of the reference projection passes through at least three points equidistant from an axis passing through a reference nozzle, which is one of the plurality of nozzles, along the ejecting direction, the at least three points being located, respectively, at mutually different positions in a circumferential direction of which center is the axis.

2. A liquid ejecting head comprising:
a channel member including:
a plurality of nozzles configured to eject a liquid;
a channel configured to supply the liquid to the plurality of nozzles; and
a reference recessed part located in a surface of the channel member and recessed in an ejecting direction of the liquid from the plurality of nozzles, wherein
an inner surface of the reference recessed part passes through at least three points equidistant from an axis passing through a reference nozzle, which is one of the plurality of nozzles, along the ejecting direction, the at least three points being located, respectively, at mutually different positions in a circumferential direction of which center is the axis.

3. The liquid ejecting head according to claim 1, wherein
the outer surface of the reference projection extends along the circumferential direction while passing through all of the three points.

4. The liquid ejecting head according to claim 1, wherein
the outer surface of the reference projection extends along the axis while passing through all of the three points.

5. The liquid ejecting head according to claim 1, wherein
the reference projection is made of a synthetic resin.

6. The liquid ejecting head according to claim 1, wherein
the reference nozzle is disposed outermost, among the plurality of nozzles, in a direction orthogonal to the ejecting direction.

7. The liquid ejecting head according to claim 1, wherein
the channel member includes a first channel member and a second channel member, wherein the plurality of nozzles and individual channels are formed in the first channel member, the individual channels are configured to supply the liquid to one of the plurality of nozzles, and the second channel member is configured to supply the liquid to the first channel member,
the second channel member is stacked on a surface, of the first channel member, opposite to a nozzle surface, of the first channel member, in which the plurality of nozzles are open, and
the reference projection is formed in the second channel member.

8. The liquid ejecting head according to claim 7, further comprising a lateral-projection projected from the second channel member in the ejecting direction up to a location adjacent to the first channel member.

9. The liquid ejecting head according to claim 8, wherein
the lateral-projection is a part projected farthest in the ejecting direction at a location outside the first channel member in a direction orthogonal to the ejecting direction.

10. The liquid ejecting head according to claim 8, wherein
a plurality of lateral-projections, including the lateral-projection, are formed in the second channel member, and
the plurality of lateral-projections are disposed so that the first channel member is interposed between the plurality of lateral-projections in the direction orthogonal to the ejecting direction.

11. A liquid ejecting apparatus comprising:
a plurality of liquid ejecting heads including the liquid ejecting head as defined in claim 8; and
a base member having a through hole, wherein
each of the plurality of liquid ejecting heads is attached to the base member in a state that the first channel member passes through the through hole from one surface to the other surface of the base member and that a forward end part of the lateral-projection is in contact with the one surface of the base member.

12. A head supporting apparatus configured to support the liquid ejecting head as defined in claim 1, the head supporting apparatus comprising:
a fitting part having a recessed part, configured to fit with the reference projection, formed therein; and
a moving mechanism configured to move the fitting part.

13. The head supporting apparatus according to claim 12, wherein
the recessed part of the fitting part has a tapered shape which becomes wider, in a direction orthogonal to the ejecting direction, further at a location closer to an opening of the recessed part, and
the reference projection has a surface along the axis.

14. The head supporting apparatus according to claim 12, wherein
the reference projection has a tapered shape which becomes narrower, in a direction orthogonal to the ejecting direction, further at a location closer to a forward end of the reference projection, and
the recessed part of the fitting part has a surface along the axis.

15. The head supporting apparatus according to claim 12, wherein
the moving mechanism includes a rotating mechanism configured to rotate the fitting part in the circumferential direction, and a translational mechanism configured to translationally move the fitting part in a direction orthogonal to the axis.

16. The head supporting apparatus according to claim 15, wherein
the rotating mechanism is disposed on the axis.
